(19) United States
(12) Patent Application Publication
(10) Pub. No.: US 2013/0234866 A1
(43) Pub. Date: Sep. 12, 2013

(54) Method for optically mixing visible and infrared lights for airfield landing aids and projecting through a shared aperture

(71) Applicants: Alan August Vetter, Duarte, CA (US); David Mark Shemwell, Newcastle, WA (US)

(72) Inventors: Alan August Vetter, Duarte, CA (US); David Mark Shemwell, Newcastle, WA (US)

(21) Appl. No.: 13/414,707

(22) Filed: Mar. 7, 2012

(51) Int. Cl. G08G 5/00

(52) U.S. Cl. 340/953

(57) ABSTRACT

This invention presents a method for mixing visible and infrared light from LED sources so light can be projected for use as landing field approach aids, such as Precision Approach Path Indicators. This method relies on the use of linear arrays of LED's and cylindrical optics.

### BACKGROUND OF THE INVENTION

It is possible to greatly reduce the electrical consumption of airfield landing aids by switching to high powered light emitting diodes (LED). Military airfields often require the use of infrared-sensitive Night Vision Goggles and other such devices by pilots on approach to landing. One example of a currently used approach aid is a Precision Approach Path Indicator (PAPI). It is desirable to have both the visible and infrared approach signals to emanate from the same aperture. Current state-of-the art clusters these LED's into a 2 dimensional array, however it is then very difficult to project the light from different LED sources so that it is mixed and provides the required intensity distribution in the approach corridor. Furthermore, the failure of any of the individual sources causes the projected intensity distribution in the approach corridors to be potentially not within the required distribution. In this invention the design uses a linear array of LED's, a linear sector partition optic, and cylindrical lenses to provide mixing of the light from the various sources to emanate from a single aperture. In addition, since the light from various sources is optically mixed, if there is a failure of a single source, the intensity distribution is not significantly changed.

LED were used in airfield landing aids as early as 1994 and combined visible/infrared (IR) LED-based landing aids were delivered to the US Army under Contract DAAH10-01-C-0039 in 2002 to be used in Operation Iraq Freedom. The Federal Aviation Administration (FAA) recognized the value of LED-based airfield landing aids and on Jan. 24, 2005 released a solicitation for a “FAA Precision Approach Path Indicator (PAPI) Light Emitting Diode (LED) Prototype”. Consequently, LED-based PAPI prototypes were built and tested by the FAA.

### SUMMARY OF THE INVENTION

In general terms the current invention uses the technique of cylindrical optics in combination with rows of visible wavelength Light Emitting Diodes (LED's) to provide approach path indications to approaching aircraft of the type known in the industry as PAPI (Precision Approach Path Indicator). For military use, a similar set of projected infrared light is used for approach to landing when pilots use Night Vision Devices, such as Night Vision Goggles. The basic function of this invention is as follows: Two sets of LED arrays, one with a mixture of white in color and infrared sources that project overlapping white and infrared light and the other array with red in color and infrared light that project overlapping red and infrared light are incident on a beam sharing optic, or alternatively on a sector delineating mask. The beam sharing optic is also linear and directs the red and infrared or white and infrared light towards the cylindrical lens, while allowing the remaining color and its associated infrared light to also proceed to the Cylindrical. The beam sharing optic also delineates the red from the white sector. The cylindrical lens then reimages the beam sharing optic so that the two sectors are properly formed for the PAPI system to function properly. The optical system must also be protected from the weather and have a means for mounting to standard airport mounting systems. In an alternate embodiment the white/infrared and red/infrared sector signals can come from separate boxes stacked on top of each other each with a linear array for the white/infrared and red/infrared sectors respectively, and separate cylindrical optical systems. In this case the beam sharing optic is replaced by a sector delineation mask in each cylindrical optical system. This invention has the advantage over current art in that the visible and infrared light is projected though the same aperture. An additional advantage is found in the linear nature of this optical system which allows for high levels of brightness of the projected light while providing a superior arrangement for cooling the LED's.

U.S. Pat. No. 7,023,361 mentions that “ it is also possible to place both a visible and an infrared lamp assembly in a runway lighting fixture to shine through a common lens or window”. However, it does not describe any embodiments which can effect a shared aperture that projects overlapping beams. In a standard imaging system, the different wavelength sources are separated spatially and will not have properly overlapping beams. The embodiment claimed here is different as it optically combines the source sectors so that the resultant light is projected in the same direction through a shared aperture.

### DESCRIPTION OF THE DRAWINGS

FIG. 1 shows the layout of the cylindrical optical system with its LED arrays, beam combining optic, and cylindrical lens system

FIG. 2 shows one specific embodiment of the LED PAPI arrangement with a cylindrical optical system

### DETAILED DESCRIPTION

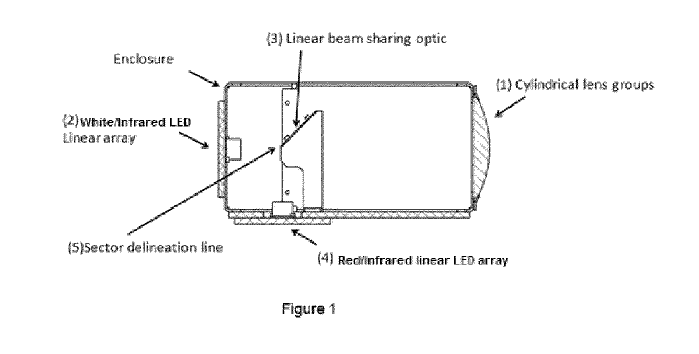

FIG. 1 shows the basic layout of the optical system. An array of LED's of the first color (2) is mounted on the optical head, while an array of LED's of the second color(4) is mounted onto the same optical head. Light from these two arrays of LED is incident on a beam sharing optic (3), or alternatively on a sector delineating masks (5). The beam sharing optic is also linear and directs the red or white light towards the cylindrical lens, while allowing the remaining color to also proceed to the Cylindrical Lens (1). The beam sharing optic also delineates the red from the white sector. The cylindrical lens then reimages the beam sharing optic so that the white and red sectors are properly formed for the PAPI system to function properly. In an alternate embodiment the white and red sector signals can come from separate boxes stacked on top of each other each with a linear array for the white and red sectors respectively, and separate cylindrical optical systems. In this case the beam sharing optic is replaced by a sector delineation mask in each cylindrical optical system.

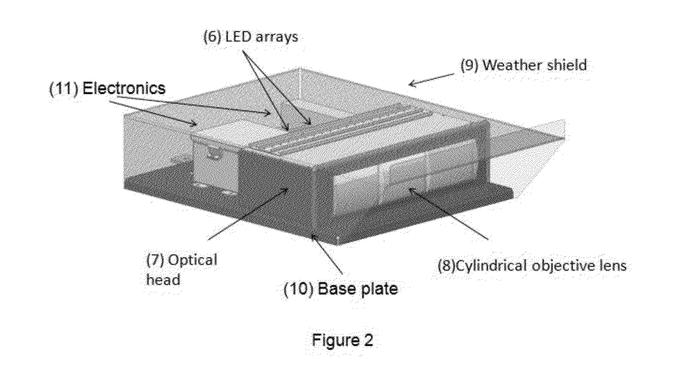

The optical system must also be protected from the weather and have a means for mounting to standard airport mounting systems, as well as placement for electronics and other supporting functions. One practical embodiment of this invention is shown in FIG. 2. As in FIG. 1, FIG. 2 shows the LED arrays (6) (one is hidden from view in this perspective but noted by the arrow), and cylindrical lens system (8). The (7) optical head to which the cylindrical lens and LED arrays are mounted is mounted on a base plate (10) that provides support for the optical head as well as the various electronic packages (11) required to drive the LED arrays and support other functions such as control of brightness and fault detections. In one such embodiment the brightness is controlled by rapidly switching the LED light on and off at a rate that cannot be detected by the human eye. This sort of brightness control is unique to the LED light source and is not available to a PAPI system with contains standard incandescent lights. The entire device is covered by a weather cover (9) for protection from rain and snow.

One advantage of this invention is that it is possible to increase the output power of this design to any level required simply by adding more LED's and optics to the linear array without encounter overheating issues. The length of the array is linear related to the total output of the device adding length will, for any given LED design, increase the possible output of the device in concert with the increase in length. The increase in length has no negative effect on the devices' performance since the cylindrical optical system integrates this linear array at the operating range making it appear to be a single light source

The optical system of this invention also provided flexibility in terms of the apparent color of the projected light. The current high powered LED's that are white in color are often not the proper color. It is possible to use a linear array of “warm white” LED's but this is not as efficient. In this design one option is to use a white, amber, and perhaps some green to achieve the proper color. The cylindrical optical system integrates these separate colors to provide the proper “aviation white” at the operating distance of the PAPI so that the white sector of the PAPI appears as a pure white to the user.

In this invention the linear nature of the optical systems allows for the LED's to be spread out linearly in their array, rather than in a two dimensional array. The linear arrangement allows for enhanced cooling of the LED array since each the waste heat from each LED can propagate laterally from the LED without encountering another LED which would lead to a buildup of waste heat. This build up of waste heat is a limiting factor for LED operation, making the linear array very advantageous.

Although the present invention has been set forth in terms of specific embodiments, it will be apparent to those of skill in the art that numerous modifications and variations can be made without departing from the true spirit and scope thereof as set forth in the following claims.

What is claimed is:

1) A visible and infrared landing aid where visible and infrared sources share the same aperture that is based on LED's arranged in a linear array in an manner that the light is optically mixed..

2) A device as in claim 1 above where the device is a Precision Approach Path Indicator system.

3) Device as in claim 1 where the device is a helicopter approach path indicator.

4) Device as in claim 1 where the device is a Medium Intensity Approach Lighting System

5) A shared aperture system where visible and infrared LEDs are in a linear array with cylindrical lens.

6) A device as in claim 1 where LEDs are protected by shunt diodes to protect loss of entire LED array.
